(19) United States
(12) Patent Application Publication
(10) Pub. No.: US 2025/0294580 A1
(43) Pub. Date: Sep. 18, 2025

(54) APPARATUS AND METHOD PERFORMED BY THE SAME IN WIRELESS COMMUNICATION SYSTEM

(71) Applicant: Samsung Electronics Co., Ltd., Suwon-si, Gyeonggi-do (KR)

(72) Inventors: Sa ZHANG, Beijing (CN); Feifei SUN, Beijing (CN)

(21) Appl. No.: 18/860,187

(22) PCT Filed: Apr. 24, 2023
(86) PCT No.: PCT/KR2023/005550

§ 371 Date: Oct. 25, 2024

(30) Foreign Application Priority Data
Apr. 27, 2022 (CN) 202210458057.0
Apr. 28, 2022 (CN) 202210470701.6
Aug. 23, 2022 (CN) 202211015005.2
Sep. 26, 2022 (CN) 202211177260.7
Nov. 4, 2022 (CN) 202211379369.9
Nov. 17, 2022 (CN) 202211460509.5

(51) Int. Cl. H04W 72/232; H04L 1/1829

(52) U.S. Cl. CPC H04W 72/232; H04L 1/1854

(57) ABSTRACT

The disclosure relates to a 5G or 6G communication system for supporting a higher data transmission rate. An apparatus and a method performed by the same in a wireless communication system are provided. The method includes receiving a plurality of downlink control information (DCI), determining an order of each DCI format of the plurality of DCI; and determining an uplink transmission resource for transmitting hybrid automatic repeat request-acknowledgement (HARQ-ACK) information based on the determined order. The invention can improve communication efficiency.

### TECHNICAL FIELD

The disclosure generally relates to a field of wireless communication, and in particular relates to an apparatus and method performed by the same in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The purpose of this application is to be able to solve at least one of the drawbacks of the prior art.

There is a need to determine an order of each DCI format of the plurality of DCI.

### Solution to Problem

According to at least one embodiment of the disclosure, a method performed by a terminal in a wireless communication system is provided. The method includes receiving a plurality of downlink control information (DCI), determining an order of each DCI format of the plurality of DCI, and determining an uplink transmission resource for transmitting hybrid automatic repeat request-acknowledgement (HARQ-ACK) information based on the determined order.

According to some embodiments of the disclosure, a terminal in a wireless communication system is also provided. The terminal includes a transceiver configured to transmit and receive signals, and a controller coupled to the transceiver and configured to perform one or more operations of the above-described methods performed by the terminal.

According to some embodiments of the disclosure, a computer-readable storage medium having one or more computer programs stored therein is also provided, wherein any of the above-described methods may be implemented when the one or more computer programs are performed by one or more processors.

### Advantageous Effects of Invention

Embodiments of the present disclosure provides methods and apparatus for determining an order of each DCI format of the plurality of DCI and determining an uplink transmission resource for HARQ-ACK information.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a schematic diagram of an example wireless network according to some embodiments of the disclosure;

FIGS. 2A and 2B illustrate example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a second transceiving node according to some embodiments of the disclosure;

FIG. 5 illustrates a flowchart of a method performed by a UE according to some embodiments of the disclosure;

FIGS. 6A-6C illustrate some examples of uplink transmission timing according to some embodiments of the disclosure;

FIG. 7 illustrates an example of bandwidth part (BWP) switching according to some embodiments of the disclosure;

FIGS. 8A and 8B illustrate examples of time domain resource allocation tables according to some embodiments of the disclosure;

FIG. 9 illustrates a flowchart of a method performed by a terminal according to some embodiments of the disclosure;

FIG. 10 illustrates a flowchart of a method performed by a terminal according to some embodiments of the disclosure.

FIG. 11 illustrates a flowchart of a method performed by a terminal according to some embodiments of the disclosure;

FIG. 12 illustrates a block diagram of a first transceiving node according to some embodiments of the disclosure; and

FIG. 13 illustrates a flowchart of a method performed by a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

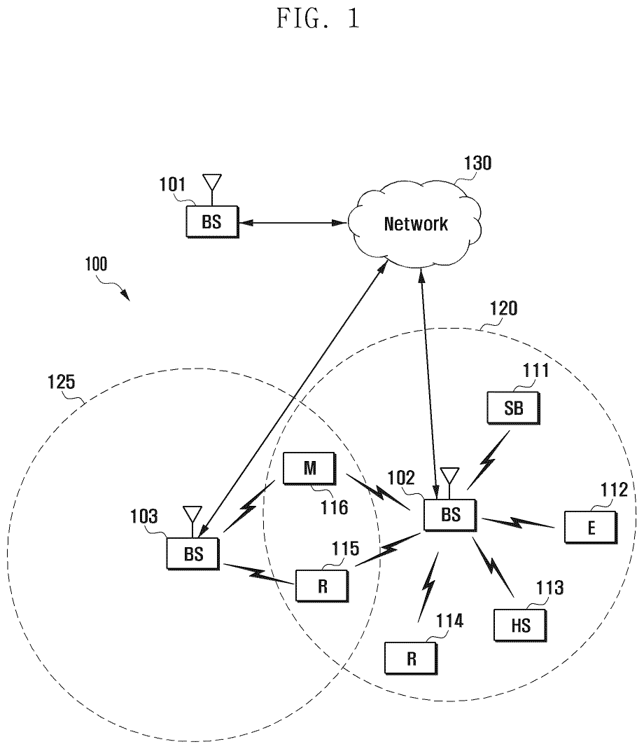

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some implementations, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some implementations, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

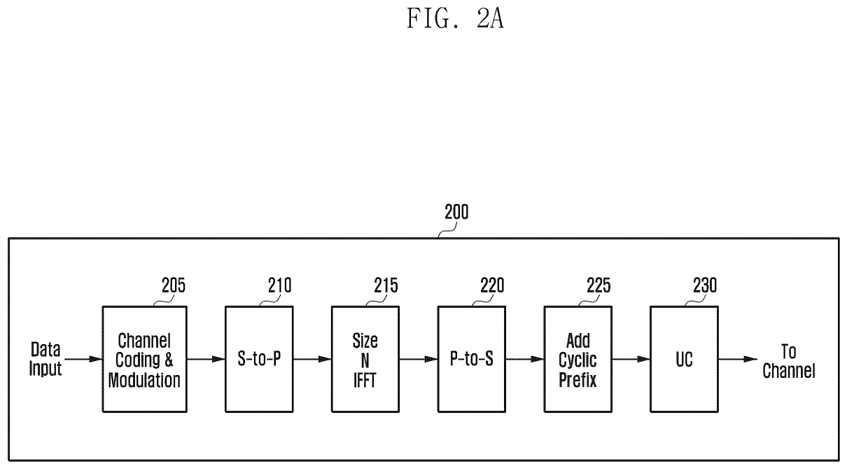

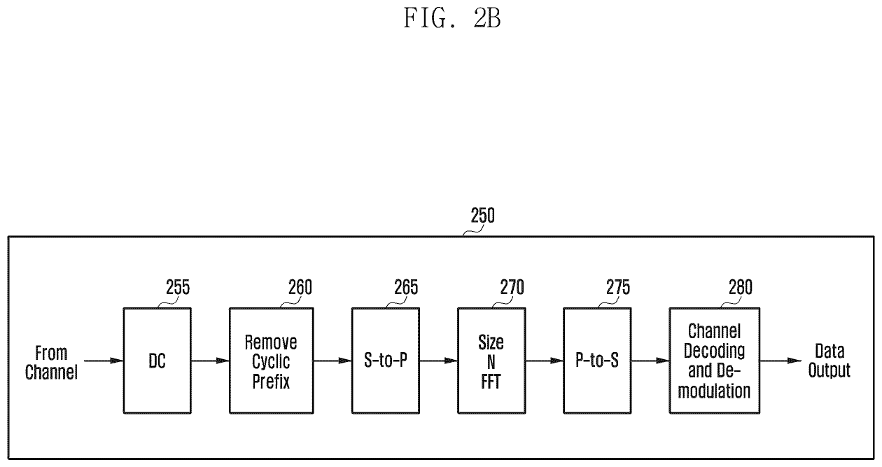

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some implementations, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

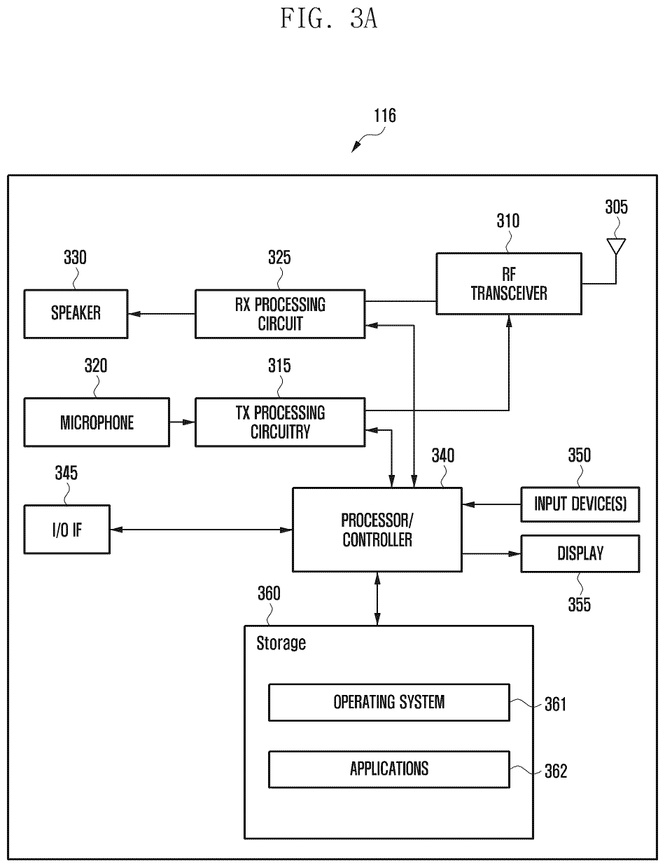

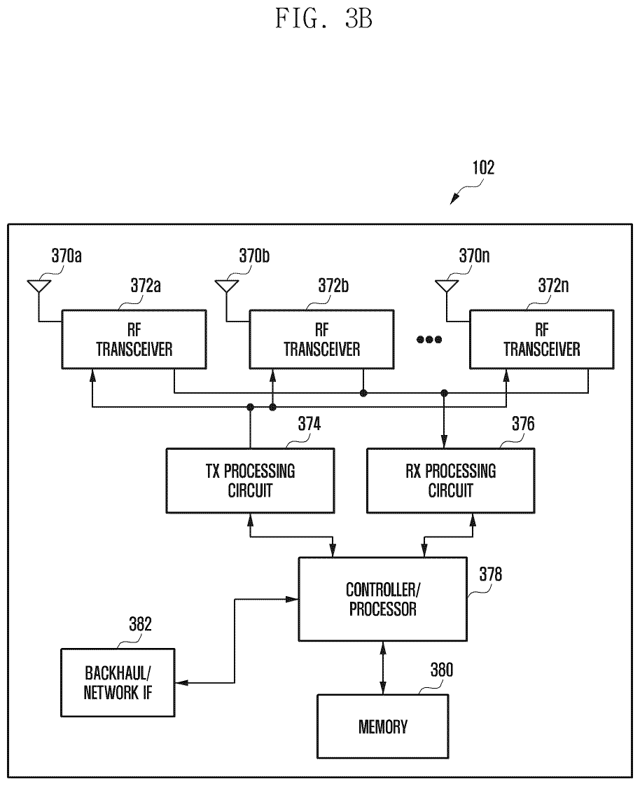

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some implementations, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some implementations, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some implementations, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some implementations, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. According to the report of International Telecommunication Union (ITU) ITU-R M.[IMT.BEYOND 2020.TRAFFIC], it can be predicted that by 2020, compared with 2010 (4G era), the growth of mobile traffic will be nearly 1000 times, and the number of UE connections will also exceed 17 billion, and the number of connected devices will be even more alarming, with the massive IoT devices gradually infiltrating into the mobile communication network. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a PDSCH time unit), the uplink time unit (e.g., a PUCCH time unit) that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In some cases, a UE may receive a DCI format, which may not schedule a PDSCH, or may schedule PDSCHs in multiple serving cells, and at this time, the UE cannot determine a one-to-one correspondence between the DCI format and the serving cell. For an order of the DCI format, the serving cell having the one-to-one correspondence to the DCI format needs to be determined for counting a downlink assignment indicator (DAI), and thus how to determine the downlink serving cell corresponding to the DCI format is a problem that needs to be solved.

When multiple DCI formats scheduling PDSCHs in a same serving cell may be received in a PDCCH monitoring occasion, or when a DCI format scheduling PDSCHs in multiple serving cells may be received in a PDCCH monitoring occasion, how to determine an order of the DCI formats and how to determine the last DCI format is a problem that needs to be solved.

In some cases, the UE may be configured by higher layer signaling to support a DCI format scheduling multiple serving cells (for example, scheduling PDSCHs and/or PUSCHs in multiple serving cells). When the UE receives a DCI format scheduling PDSCHs in multiple serving cells, how to generate a HARQ-ACK codebook is a problem that needs to be solved.

In order to at least solve one or more of the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Exemplary embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

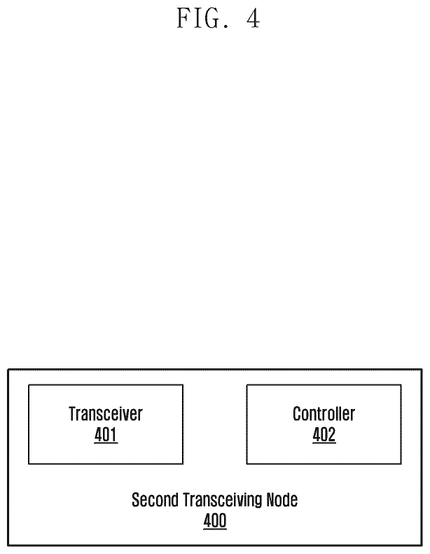

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in the embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

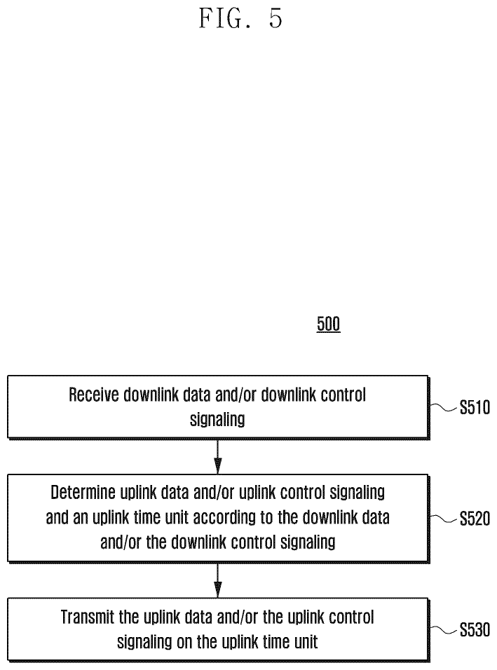

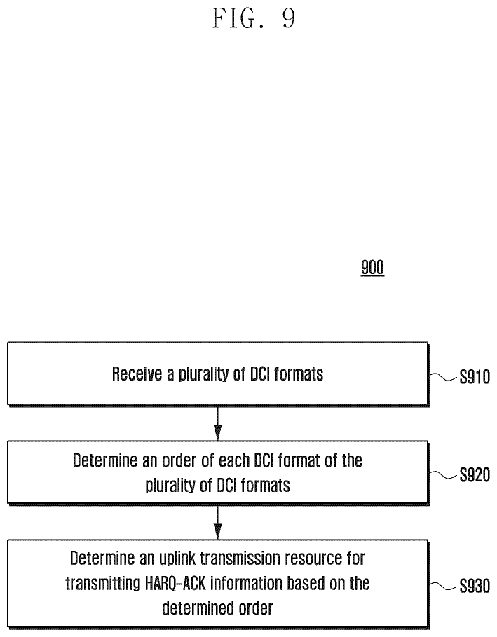

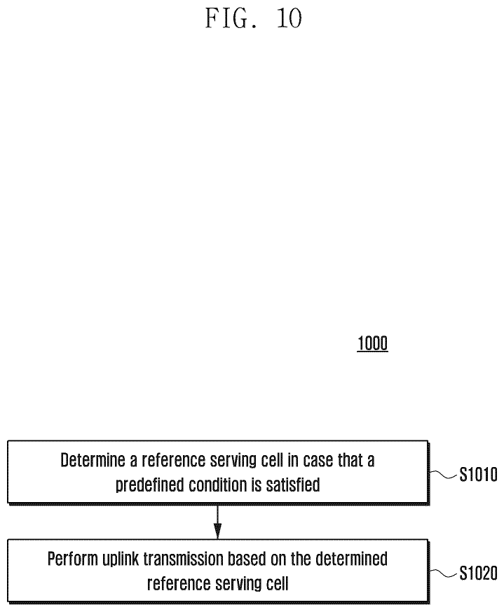

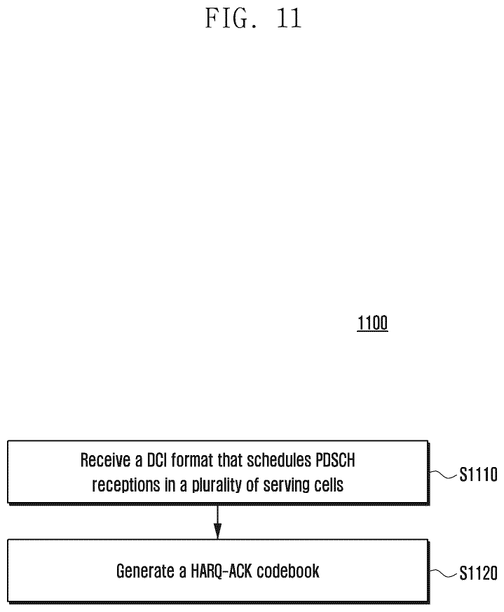

In some implementations, the controller 402 may be configured to perform one or more of operations in methods of various embodiments described below. For example, the controller 402 may be configured to perform one or more of operations in a method 500 to be described in connection with FIG. 5, a method 900 described in connection with FIG. 9, a method 1000 described in connection with FIG. 10 and a method 1100 described in connection with FIG. 11 later.

In some implementations, the first data may be data transmitted by the first transceiving node to the second transceiving node. In the following examples, downlink data carried by a PDSCH (Physical Downlink Shared Channel) is taken as an example (but not limited thereto) to illustrate the first data.

In some implementations, the second data may be data transmitted by the second transceiving node to the first transceiving node. In the following examples, uplink data carried by a PUSCH (Physical Uplink Shared Channel) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH carrying SR may be a PUCCH carrying positive SR and/or negative SR. SR may be positive SR and/or negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit or a downlink slot is taken as an example (but not limited thereto) to illustrate the first time unit.

In some implementations, a second time unit is a time unit in which the second transceiving node transmits the second data and/or the second control signaling. In the following examples, an uplink time unit or an uplink slot or a PUCCH slot or a PCell (primary cell) slot or a PUCCH slot on a PCell is taken as an example (but not limited thereto) to illustrate the second time unit. A “PUCCH slot” may be understood as a slot for PUCCH transmission.

In some implementations, the first time unit and the second time unit may be one or more slots, one or more subslots, one or more OFDM symbols, one or more spans, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (MAC CE).

FIG. 5 illustrates a flowchart of a method performed by a UE according to embodiments of the disclosure.

Referring to FIG. 5, in step S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration information (e.g., configuration parameters).

In step S520, the UE determines uplink data and/or uplink control signaling and an uplink time unit based on the downlink data and/or downlink control signaling.

In step S530, the UE transmits the uplink data and/or the uplink control signaling to the base station in an uplink time unit.

In some implementations, acknowledgement/negative acknowledgement (ACK/NACK) for downlink transmissions may be performed through HARQ-ACK.

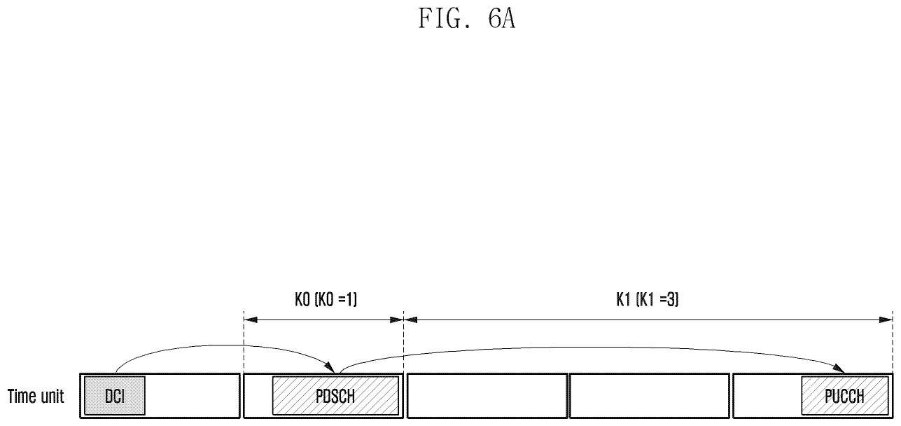

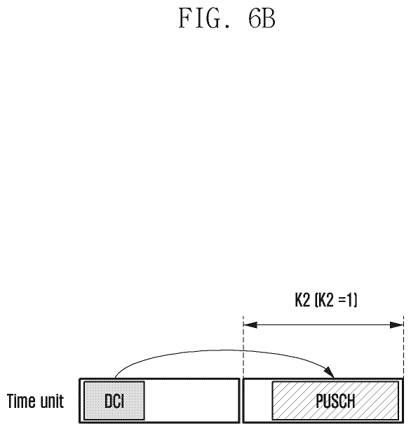

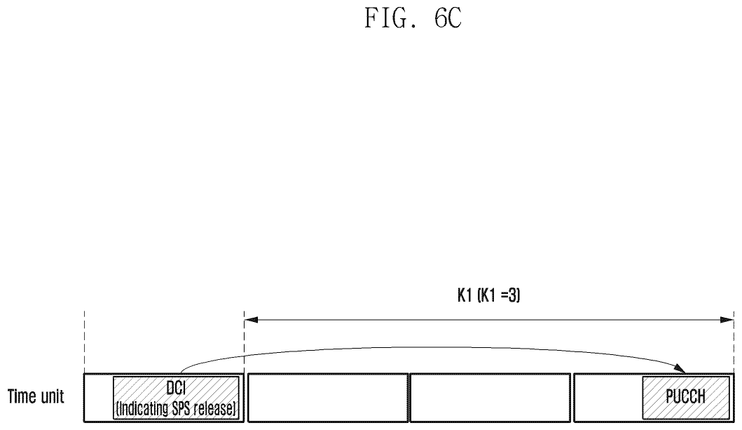

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A-6C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives DCI” may mean that “the UE detects the DCI”.

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in embodiments of the disclosure) and/or a PUSCH not scheduled by DCI (e.g., CG PUSCH).

In yet another example, the UE receives the PDSCH, and may transmit HARQ-ACK information for the PDSCH reception in a PUCCH in the uplink time unit. For example, a timing parameter (which may also be referred to as a timing value) K1 (e.g., the parameter dl-DataToUL-ACK) may be used to represent a time interval between the PUCCH for transmitting the HARQ-ACK information for the PDSCH reception and the PDSCH, and K1 may be in units of uplink time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 6A gives an example in which K1=3. In the example illustrated in FIG. 6A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K1, the timing parameter K0 may be used interchangeably with a timing parameter K0, and the timing parameter K2 may be used interchangeably with a timing parameter K2.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the timing parameter K1 may be used to represent a time interval between the PUCCH for transmitting the HARQ-ACK information for the DCI and the DCI, and K1 may be in units of uplink time units, such as slots or subslots. For example, FIG. 6C gives an example in which K1=3. In the example of FIG. 6C, the time interval between the PUCCH for transmitting the HARQ-ACK information for the DCI and the DCI is 3 slots. For example, the timing parameter K1 may be used to represent a time interval between a PDCCH reception with DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

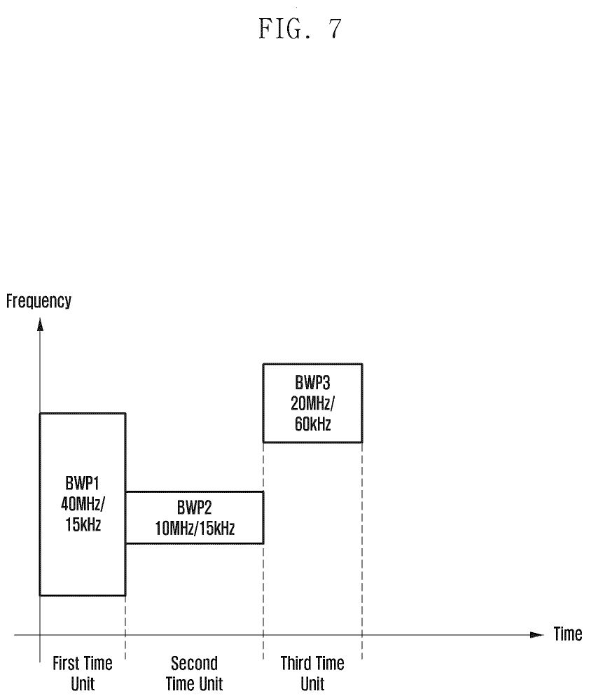

In NR, the bandwidth of a UE may change dynamically. The base station may configure multiple BWPs (Bandwidth Parts) for the UE through higher layer signaling. The base station may activate one BWP of the multiple BWPs. For example, the activated BWP may be the active BWP. The base station may also indicate to switch from the current active BWP to another BWP through signaling (e.g., DCI) (which may be called active BWP switching or change, or simply BWP switching or change). For example, the other BWP switched to becomes the active BWP. When the UE receives an indication of BWP switching, the activated BWP is deactivated and the other BWP is activated. FIG. 7 illustrates an example of BWP switching according to embodiments of the disclosure. As shown in FIG. 7, in the first time unit, the amount of services of the UE is large, and the system configures a large bandwidth (BWP1) for the UE; in the second time unit, the amount of services of the UE is small, and the system configures a small bandwidth (BWP2) for the UE to just meet basic communication requirements; and in the third time unit, the system may find that there is a wide range of frequency selective fading in the bandwidth of BWP1, or the resource in the frequency range of BWP1 is scarce, so a new bandwidth (BWP3) may be configured to the UE.

The UE only needs to adopt the center frequency and sampling rate of a corresponding BWP in the corresponding BWP. Moreover, each BWP is not only different in frequency and bandwidth, but also can correspond to different configurations. For example, the subcarrier spacing, CP type, SSB (synchronization signal and PBCH block) (including Primary Synchronization Signal (PSS), Secondary Synchronization Signal (SSS) and PBCH) period of each BWP can be configured differently to adapt to different services.

In some implementations, the UE may be configured with two levels of priorities for uplink transmission. For example, the UE may be configured to multiplex UCIs with different priorities via higher layer signaling (e.g., through the parameter UCI-MuxWithDifferentPriority); otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

In some examples, multiplexing multiple uplink transmissions (e.g., PUCCH and/or PUSCH) overlapping in time domain may be multiplexing UCI information carried in the PUCCH in one PUCCH or PUSCH.

In some examples, the prioritization of two uplink transmissions (e.g., PUCCH and/or PUSCH) overlapping in time domain by the UE may include the UE transmitting an uplink transmission (e.g., PUCCH or PUSCH) of a higher priority and not transmitting an uplink transmission (e.g., PUCCH or PUSCH) of a lower priority.

In some implementations, the UE may be configured with a subslot-based PUCCH transmission. For example, a subslot length parameter (which may also be referred to as a parameter with respect to a subslot length in embodiments of the disclosure) (e.g., the parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols.

Subslot configuration length parameters in different PUCCH configuration parameters may be configured separately. If no subslot length parameter is configured in a PUCCH configuration parameter, the scheduling time unit of this PUCCH configuration parameter is one slot by default. If a subslot length parameter is configured in the PUCCH configuration parameter, the scheduling time unit of this PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the parameter subslotLengthForPUCCH), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., SPS PDSCH release, and/or indicating secondary cell dormancy (Scell dormancy), and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast or groupcast may refer to a manner in which a network communicates with multiple UEs. For example, a unicast PDSCH may be a PDSCH received by a UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (may be referred to as Group RNTI (G-RNTI) in embodiments of the disclosure) for scrambling of a dynamically scheduled multicast transmission (e.g., PDSCH) or an RNTI (may be referred to as Group configured scheduling RNTI (G-CS-RNTI) in embodiments of the disclosure) for scrambling of a multicast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same uplink time unit, the UE may generate the HARQ-ACK codebook based on a predefined rule. For example, if a PDSCH is successfully decoded, the HARQ-ACK information for this PDSCH reception is positive ACK. The positive ACK may be represented by 1 in the HARQ-ACK codebook, for example. If a PDSCH is not successfully decoded, the HARQ-ACK information for this PDSCH reception is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of a SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that in the embodiments of the disclosure, “A” overlapping with “B” may mean that “A” at least partially overlaps with “B”. That is, “A” overlapping with “B” includes the case that “A” completely overlaps with “B”. “A” overlapping with “B” may mean that “A” overlaps with “B” in time domain and/or “A” overlaps with “B” in frequency domain.

In some implementations, if HARQ-ACK information transmitted in a same uplink time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same uplink time unit only includes HARQ-ACK information for one or more SPS PDSCH receptions, the UE may generate HARQ-ACK information (for example, HARQ-ACK information only for SPS PDSCH receptions) according to a rule for generating a SPS PDSCH HARQ-ACK codebook. The UE may multiplex HARQ-ACK information only for SPS PDSCH receptions in a specific PUCCH resource. For example, if the UE is configured with a parameter of a SPS PUCCH list (e.g., SPS-PUCCH-AN-List), the UE multiplexes the HARQ-ACK information only for SPS PDSCH receptions in a PUCCH in the SPS PUCCH list. For example, the UE determines one PUCCH resource in the SPS PUCCH list according to the number of HARQ-ACK bits. If the UE is not configured with the parameter of the SPS PUCCH list, the UE multiplexes the HARQ-ACK information only for SPS PDSCH receptions in a PUCCH resource specific to SPS HARQ-ACK (for example, the PUCCH resource configured by a parameter n1PUCCH-AN).

In some implementations, if HARQ-ACK information transmitted in a same uplink time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook) or a dynamic HARQ-ACK codebook (e.g., Type-2 HARQ-ACK codebook) according to a PDSCH HARQ-ACK codebook configuration parameter (e.g., the parameter pdsch-HARQ-ACK-Codebook). The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information to the dynamically scheduled PUCCH resources for HARQ-ACK, which may be configured in a resource set list parameter (e.g., the parameter resourceSetToAddModList). The UE determines a PUCCH resource set (e.g., the parameter PUCCH-ResourceSet) in the resource set list according to the number of HARQ-ACK bits, and the PUCCH resource may determine a PUCCH in the PUCCH resource set according to a PRI (PUCCH resource indicator) field indication in the last DCI format.

In some implementations, if HARQ-ACK information transmitted in a same uplink time unit includes only HARQ-ACK information for a SPS PDSCH (e.g., a PDSCH not scheduled by a DCI format), the UE may generate the HARQ-ACK codebook according to a rule for generating a HARQ-ACK codebook for a SPS PDSCH reception (e.g., the pseudo code for generating a HARQ-ACK codebook for a SPS PDSCH reception).

For the semi-static HARQ-ACK codebook (e.g., Type-1 HARQ-ACK codebook), it may determine the size of the HARQ-ACK codebook and an order of HARQ-ACK bits according to a semi-statically parameter (e.g., a parameter configured by higher layer signaling). For a serving cell c, an active downlink BWP (bandwidth part) and an active uplink BWP, the UE determines a set of M_{A,c}, occasions for candidate PDSCH receptions for which the UE can transmit corresponding HARQ-ACK information in a PUCCH in an uplink slot n_{U}.

M_{A,c} may be determined by at least one of:
a) HARQ-ACK slot timing values K1 of the active uplink BWP;
b) a downlink time domain resource allocation (TDRA) table;
c) an uplink SCS configuration and a downlink SCS configuration;
d) a semi-static uplink and downlink frame structure configuration;
e) a downlink slot offset parameter (e.g., parameter N_{slot,offset,c}^{DL}) for the serving cell c and its corresponding slot offset SCS (e.g., parameter μ_{offset, DL,c}), and a slot offset parameter (e.g., parameter N_{slot,offset}^{UL}) for a primary serving cell and its corresponding slot offset SCS (e.g., parameter μ_{offset,UL}).

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a starting symbol may be used interchangeably with a start position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back may be determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a start OFDM symbol is 0 and an OFDM symbol length is 4; for the second row of the time domain resource allocation table, the start OFDM symbol is 4 and the OFDM symbol length is 4; and for the third row of the time domain resource allocation table, the start OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

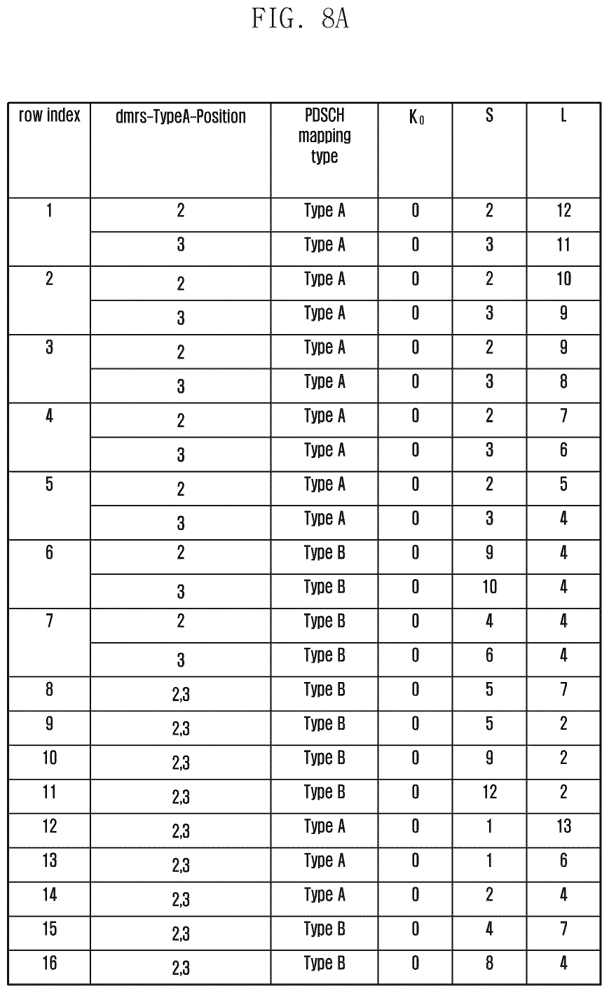

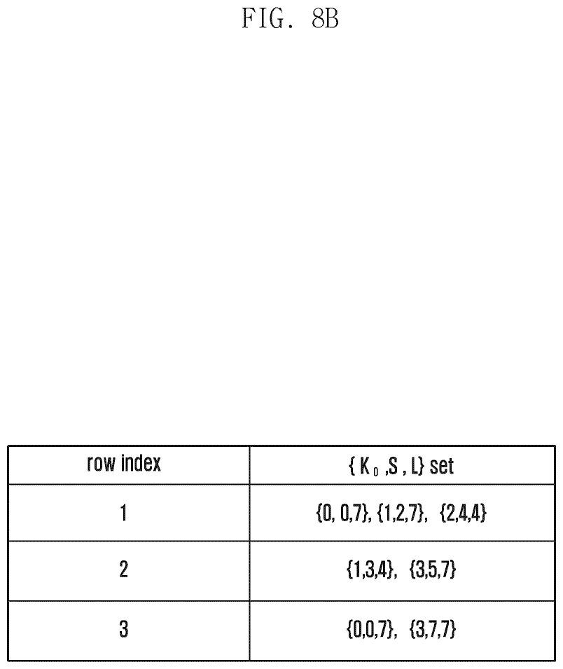

FIGS. 8A and 8B illustrate examples of a time domain resource allocation table. Specifically, FIG. 8A illustrates a time domain resource allocation table in which one PDSCH is scheduled by one row, and FIG. 8B illustrates a time domain resource allocation table in which multiple PDSCHs are scheduled by one row. Referring to FIG. 8A, each row corresponds to a value of a timing parameter K0, a value of S indicating a starting symbol, and a value of L indicating a length, where an SLIV may be determined by the value of S and the value of L. Referring to FIG. 8B, unlike FIG. 8A, each row corresponds to values of multiple sets of {K0, S, L}.

In some implementations, the dynamic HARQ-ACK codebook (e.g., Type-2 HARQ-ACK codebook) and/or the enhanced dynamic HARQ-ACK codebook (e.g., Type-2 HARQ-ACK codebook based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a C-DAI (Counter-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m}, V_{T-DAI,c,m} or V_{T-Dai}^{UL}. Numbers of bits of the C-DAI and T-DAI are limited. For example, in a case where the C-DAI or T-DAI is represented with 2 bits, the value of the C-DAI or T-DAI in the DCI may be determined by equations in Table 1. V_{T-DAI,m} or V_{T-DAi}^{UL} is the value of the T-DAI in DCI received in a PDCCH Monitoring Occasion (MO) m, and V_{C-DAI,c,m} is the value of the C-DAI in DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| | V_{T-DAI, m} or | |
|---|---|---|
| MSB, LSB of | V_{C-DAI, c, m} or | |
| DAI Field | V_{T-DAI}^{UL} | Y |
| 0, 0 | 1 | (Y − 1) mod 4 + 1 = 1 |
| 0, 1 | 2 | (Y − 1) mod 4 + 1 = 2 |
| 1, 0 | 3 | (Y − 1) mod 4 + 1 = 3 |
| 1, 1 | 4 | (Y − 1) mod 4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table).

For example, in a case where the C-DAI or T-DAI in the DCI is 1 bit, values greater than 2 may be represented by equations in Table 2.

TABLE 2

| | V_{T-DAI, m} or | |
|---|---|---|
| DAI field | V_{C-DAI, c, m} | Y |
| 0 | 1 | (Y − 1) mod 2 + 1 = 1 |
| 1 | 2 | (Y − 1) mod 2 + 1 = 2 |

In some implementations, whether to feed back (or report) HARQ-ACK information may be configured by a higher layer parameter or dynamically indicated by DCI. A mode for feeding back (or reporting) HARQ-ACK information (HARQ-ACK feedback mode or HARQ-ACK reporting mode) may be at least one of the following modes.
HARQ-ACK feedback mode 1: transmitting ACK or NACK (ACK/NACK). For example, for a PDSCH reception, if the UE correctly decodes a corresponding transport block (TB), the UE transmits ACK; and/or, if the UE does not correctly decode the corresponding transport block, the UE transmits NACK. For example, the HARQ-ACK information bit of the HARQ-ACK information provided according to the HARQ-ACK feedback mode 1 is an ACK value or a NACK value.
HARQ-ACK feedback mode 2: transmitting only NACK (NACK-only). For example, for a PDSCH reception, if the UE correctly decodes a corresponding transport block, the UE does not transmit HARQ-ACK information; and/or, if the UE does not correctly decode the corresponding transport block, the UE transmits NACK. For example, at least one HARQ-ACK information bit of HARQ-ACK information provided according to HARQ-ACK feedback mode 2 is a NACK value. For example, in the HARQ-ACK feedback mode 2, the UE does not transmit a PUCCH that would include only HARQ-ACK information with ACK values.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be PDCCH and/or DCI and/or DCI format. For example, SPS PDSCH and/or CG PUSCH may be dynamically indicated in corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, parameters in the embodiments of the disclosure may be higher layer parameters. For example, the higher layer parameters may be parameters configured or indicated by higher layer signaling (e.g., RRC signaling).

It should be noted that, a PCell (Primary Cell) or PSCell (Primary Secondary Cell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling of multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured and/or indicated with a transmission with repetitions” may be understood that the number of the repetitions of the transmission is greater than 1. For example, “configured and/or indicated with a transmission with repetitions” may be replaced with “PUCCH repeatedly transmitted on more than one slot/sub-slot”. “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1”. For example, the UE may be configured with a parameter N_{PUCCH}^{repeat} related to the number of repetitions of PUCCH; When the parameter N_{PUCCH}^{repeat} is greater than 1, it may mean that the UE is configured with a PUCCH transmission with repetitions, and the UE may repeat the PUCCH transmission on N_{PUCCH}^{repeat} time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that the multiple manners described in the disclosure may be combined in any order. In a combination, a manner may be performed one or more times.

It should be noted that the steps in the methods of the disclosure may be implemented in any order.

It should be noted that, in methods of the disclosure, “canceling a transmission” may mean canceling the transmission of the entire uplink channel and/or cancelling the transmission of a part of the uplink channel.

It should be noted that, in methods of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in methods of the disclosure, a PUCCH/PUSCH carrying A may be understood as a PUCCH/PUSCH only carrying A, and may also be understood as a PUCCH/PUSCH carrying at least A.

It should be noted that “slot” may be replaced by “subslot” or “time unit” in embodiments of the disclosure.

It should be noted that “at least one” in embodiments of the disclosure may be understood as “one” or “multiple”. In the case of “multiple”, it may be any permutation and combination. For example, at least one of A, B and C may be: A, B, C, A-B, B-A, A-B-C, C-B-A, A-B-C-A, A-B-C-C-B, etc.

It should be noted that, slots in embodiments of the disclosure may also be replaced with other time units.

It should be noted that, in embodiments of the disclosure, “if a predefined condition is satisfied, a predefined method (or step) is performed” and “if a predefined condition is not satisfied, a predefined method (or step) is not performed” can be used interchangeably. “If a predefined condition is satisfied, a predefined method (or step) is not performed” and “if a predefined condition is not satisfied, a predefined method (or step) is performed” can be used interchangeably.

It should be noted that, in embodiments of the disclosure, parameters, information or configuration can be pre-configured or pre-defined or configured by the base station. Therefore, in some cases, parameters, information or configuration can be referred to as predefined parameters, predefined information or predefined configuration, respectively. In the embodiments of the disclosure, the meaning of pre-configuring certain information or parameters in the UE can be interpreted as default information or parameters embedded in the UE when the UE is manufactured, or information or parameters acquired and stored in the UE in advance through higher layer signaling (e.g., RRC) configuration, or information or parameters acquired and stored from the base station.

It should be noted that, in embodiments of the disclosure, “HARQ-ACK information bits” and “HARQ-ACK bits” can be used interchangeably.

In some cases, a UE may receive a DCI format, which may not schedule a PDSCH, or may schedule PDSCHs in multiple serving cells, and at this time, the UE cannot determine a one-to-one correspondence between the DCI format and the serving cell. For an order of the DCI format, the serving cell having the one-to-one correspondence to the DCI format needs to be determined for counting a DAI, and thus how to determine the downlink serving cell corresponding to the DCI format is a problem that needs to be solved.

In some implementations, if a predefined condition is satisfied, a reference serving cell may be determined according to Manner MN2. The predefined condition may be determined in Manner MN1.

### Manner MN1

In some implementations, the predefined condition may be at least one of the following conditions COND1-COND6.

COND1: the UE receives a DCI format scheduling PDSCHs in multiple serving cells.

COND2: the UE receives a DCI format without scheduling a PDSCH.

COND3: the UE receives a DCI format triggering HARQ-ACK retransmission.

COND4: the UE receives a DCI format indicating secondary cell deactivation.

COND5: the UE receives a DCI format triggering a Type-3 HARQ-ACK codebook. The Type-3 HARQ-ACK codebook may be a codebook to feed back HARQ-ACK information for all HARQ processes.

COND6: the UE receives a DCI format triggering a TCI state update.

It should be noted that, the above conditions COND1-COND6 may be further defined as having associated HARQ-ACK information. For example, the DCI format may be a DCI format scheduling a PDSCH and indicating HARQ-ACK information for the PDSCH to be fed back in a PUCCH. For example, the DCI format may be a DCI format without scheduling a PDSCH and indicating HARQ-ACK information to be fed back in a PUCCH. At this time, the HARQ-ACK information may be HARQ-ACK information for the DCI format. In other embodiments of the disclosure, the de-termination of either an ordering rule or the last DCI format may consider that all the multiple DCI formats involved indicate that their HARQ-ACK information is fed back in one PUCCH.

### Manner MN2

In some implementations, the reference serving cell may be at least one of the following:
a serving cell with the smallest (or largest) index of serving cells where PDSCHs scheduled by the DCI format are located.
a serving cell with the smallest (or largest) index of serving cells where PDSCHs scheduled by the DCI format are located, where the PDSCHs are PDSCHs that do not overlap with uplink symbols configured by higher layer signaling (for example, parameters tdd-UL-DL-ConfigurationCommon and/or tdd-UL-DL-ConfigurationDedicated) in time domain.
the first (or last) serving cell in a set of serving cells indicated by the DCI format.
a serving cell with the smallest index (or the largest index) of serving cells where PDSCHs in the set of serving cells indicated by the DCI format are located, where the PDSCHs are PDSCHs that do not overlap with uplink symbols configured by higher layer signaling (for example, parameters tdd-UL-DL-ConfigurationCommon and/or tdd-UL-DL-ConfigurationDedicated) in time domain.
a serving cell determined based on a carrier indicator field. For example, if there is a carrier indication field in the DCI format, the reference serving cell is determined according to the carrier indication field in the DCI format, and if there is no carrier in-dication field in the DCI format, the reference serving cell is determined according to the serving cell where the PDCCH is located.
a serving cell where the PDCCH carrying the DCI format is located.
a serving cell where the PDSCH scheduled by the DCI format is located.

In some implementations, the UE may determine at least one of the following according to the determined reference serving cell:
an order of DCI formats. For example, the order of DCI formats may be determined according to the manners in other embodiments of the disclosure, for example, one or more of Manners MN3-MN8.
DAI counting. For example, when counting a DAI, {serving cell, time unit} pair(s) may be determined with the determined reference serving cell. In an example, the UE receives a DCI format scheduling PDSCHs in multiple serving cells with HARQ-ACK to be transmitted in a same PUCCH. The serving cell with the smallest index of the scheduled multiple serving cells may be used as the reference serving cell, and HARQ-ACK bits for the PDSCHs in the scheduled multiple serving cells may be ordered according to an ascending order of the serving cell indexes.
a PUCCH time unit carrying HARQ-ACK (for example, a slot of the PUCCH). For example, the UE receives a DCI format scheduling PDSCHs in multiple serving cells with HARQ-ACK to be transmitted in a same PUCCH, and the UE determines a slot of the PUCCH according to the PDSCH in the reference serving cell and K1 indicated in the DCI format.

This method can simplify the implementations of the UE and base station by determining the reference serving cell, and after determining the reference serving cell, the existing manners can be reused to determine the last DCI format, the DAI counting and the slot of PUCCH carrying HARQ-ACK.

In some implementations, it may also be specified by protocols that if a DCI format scheduled PDSCH reception(s), the reference serving cell is determined according to Manner MN2, and if a DCI format does not schedule PDSCH receptions and indicate HARQ-ACK information, the reference serving cell is the serving cell of the PDCCH carrying the DCI format. Or, if a DCI format schedules PDSCH reception(s) or indicates SPS PDSCH release, the reference serving cell is determined according to Manner MN2, and if a DCI format does not schedule PDSCH receptions and indicate HARQ-ACK information, and does not indicate SPS PDSCH release, the reference serving cell is the serving cell of the PDCCH carrying the DCI format.

This method is simple to define the reference cell for a DCI format without scheduling PDSCH receptions, and thus can reduce the implementation complexity of the UE.

In some cases, for a PUCCH transmission with HARQ-ACK information, the UE may determine a PUCCH resource for the PUCCH transmission. The determination of the PUCCH resource may be based on the last DCI format of DCI formats (e.g., excluding SPS activation DCI) indicating a same time unit (e.g., a same slot) (e.g., the DCI formats pointing to the same time unit through K1 field (e.g., PDSCH-to-HARQ_feedback timing indicator field)), where the UE receives (e.g., detects) the DCI formats and transmits corresponding HARQ information therefor in the PUCCH. For example, the UE may receive multiple DCI formats indicating (e.g., indicating by K1 field in the DCI formats) that HARQ-ACK is transmitted in a PUCCH in a same time unit (e.g., a same slot), and the UE may determine that a DCI format with the largest serving cell index of the DCI formats received (e.g., detected) in the last PUCCH monitoring occasion is the last DCI format. When multiple DCI formats scheduling PDSCHs in a same serving cell may be received in a PDCCH monitoring occasion, or when a DCI format scheduling PDSCHs in multiple serving cells may be received in a PDCCH monitoring occasion, how to determine an order of the DCI formats and how to determine the last DCI format is a problem that needs to be solved.

In some implementations, the order of the DCI formats may be determined according to at least one of the following Manners MN3-MN6. For example, the UE may determine the last DCI format according to an ordering rule determined, and determine the PUCCH resource according to a PUCCH resource indicator (PRI) in the last DCI format.

### Manner MN3

The detected DCI formats are indexed first in an ascending order of times (e.g., starting times or end times) of the scheduled PDSCHs in the same serving cell in the same PDCCH monitoring occasion, then (e.g., second) indexed in an ascending order of serving cell indexes in the same PDCCH monitoring occasion, and then (e.g., third) indexed in an ascending order of PDCCH monitoring occasion indexes.

### Manner MN4

If the UE receives a DCI format scheduling PDSCHs in multiple serving cells, the order of the DCI format may be determined according to a serving cell with the largest (or smallest) index of the scheduled serving cells. For example, when the detected DCI formats (for example, in the same PDCCH monitoring occasion) are indexed in an ascending order of the serving cell indexes (for example, in Manner MN3), for a DCI format scheduling PDSCHs in multiple serving cells among the detected DCI formats, a serving cell for indexing the DCI formats (in embodiments of the disclosure, it may be referred to as a reference serving cell related to indexing of the DCI formats) is determined as the serving cell with the largest (or smallest) index of the multiple serving cells scheduled by the DCI format, and the order of the DCI format may be determined based on an index of the serving cell for indexing.

### Manner MN5

If the UE receives a DCI format scheduling PDSCHs in multiple serving cells, the order of the DCI format is determined according to a serving cell with the largest (or smallest) index, of the serving cells where the scheduled PDSCHs are located, where the PDSCHs are PDSCHs that do not overlap with uplink symbols configured by higher layer signaling (for example, parameters tdd-UL-DL-ConfigurationCommon and/or tdd-UL-DL-ConfigurationDedicated) in time domain.

### Manner MN6

If the UE receives a DCI format (for example, DCI format 1_1) indicating secondary cell dormancy, a serving cell corresponding to the DCI format is determined according to at least one of the following items (for example, the serving cell corresponding to the DCI format is determined as at least one of the following), and the order of the DCI format is determined according to the determined serving cell:
a serving cell with the largest (or smallest) index of serving cells configured to enable dormancy (for example, the serving cells configured with the parameter dormancyGroupWithinActiveTime);
a serving cell with the largest (or smallest) index of serving cells for which the DCI format indicates dormancy;
a serving cell with the largest (or smallest) index of serving cells for which the DCI format does not indicate dormancy.

For example, when the detected DCI formats (e.g., in the same PDCCH monitoring occasion) are indexed in an ascending order of the serving cell indexes (e.g., in Manner MN1), for a DCI format indicating secondary cell dormancy of the detected DCI formats, a serving cell used for indexing the DCI format (a reference serving cell related to DCI indexing) may be determined as at least one of the items listed above, and the order of the DCI format may be determined based on the index of the serving cell used for indexing.

### Manner MN7

If the UE receives a DCI format (for example, DCI format 1_1 or DCI format 1_2) indicating HARQ-ACK feedback for all HARQ processes (for example, Type-3 HARQ-ACK codebook), the DCI format is the last DCI format.

### Manner MN8

The UE receives a DCI format indicating HARQ-ACK retransmission (for example, DCI format 1_1 or DCI format 1_2). For example, the UE receives a DCI format without scheduling a PDSCH in slot n, which indicates that HARQ-ACK in slot m is transmitted in slot n+k. A serving cell corresponding to the DCI format is determined according to at least one of the following items (for example, determining that the serving cell corresponding to the DCI format is at least one of the following), and determines the order of the DCI format according to the determined serving cell.
a cell index of a primary serving cell
a cell with the largest (or smallest) index configured by higher layer signaling
the largest cell index +x, where x may be a positive integer, for example, x is equal to 1. Or, the DCI format is considered to be the last DCI format in the same PDCCH monitoring occasion.
the smallest cell index −x, where x may be a positive integer, for example, x is equal to 1. Or, the DCI format is considered to be the first DCI format in the same PDCCH monitoring occasion.

It should be noted that this method is also applicable to a DCI format indicating secondary cell dormancy (for example, DCI format 1_1) and/or a DCI format indicating HARQ-ACK feedback for all HARQ processes (for example, DCI format 1_1 or DCI format 1_2).

It should be noted that the last DCI format may be determined according to ordering rules of DCI formats in embodiments of the disclosure, and a PUCCH resource may be determined according to a PRI in the last DCI format. For example, a PUCCH, for example, a PUCCH with HARQ-ACK information, may be transmitted on the determined PUCCH resources.

In some cases, the UE may receive one or more DCI formats indicating SPS PDSCH release, and/or one or more DCI formats scheduling PDSCH receptions, and/or one or more DCI formats indicating secondary cell dormancy in a same PDCCH monitoring occasion, and an ordering rule of the DCI formats need to be defined.

In some cases, at least one of Manners MN3-MN6 and MN12-MN19 may be adopted to determine the order of the DCI, so as to determine the last DCI format (for example, to determine a DCI format for carrying HARQ-ACK) and/or to determine the ordering for DAI counting.

### Manner MN12

It may be specified by protocols that for multiple DCI formats received in a same PDCCH monitoring occasion, if all the multiple DCI formats correspond to a same serving cell (for example, a reference serving cell; for another example, a serving cell in which the scheduled PDSCH is located), a DCI format indicating SPS PDSCH release is before (or after) a DCI format scheduling PDSCH receptions. For the DCI formats indicating SPS PDSCH release, the order of the DCI formats may be determined according to the order (for example, an ascending order; for another example, an descending order) of indexes of SPS PDSCHs indicated in the DCI formats. If the DCI format indicates the release of multiple SPS PDSCH configurations, the SPS PDSCH configuration index corresponding to the DCI format may be determined according to the smallest (or largest) index of the multiple SPS PDSCH configurations.

The method specifies the ordering rule of DCI indicating SPS PDSCH release, which can clarify the ordering for DAI and/or the determination of a PUCCH resource, and can improve the reliability of uplink transmission.

### Manner MN13

It may be specified by protocols that when multiple DCI formats satisfy a predefined Condition 2, a DCI format scheduling a PDSCH reception is before or after a DCI format without scheduling a PDSCH reception. It may be specified by protocols that the UE does not expect to receive multiple DCI formats satisfying a predefined Condition 3.

The predefined Condition 2 may be at least one of the following:
the multiple DCI formats are received in a same PDCCH monitoring occasion
the multiple DCI formats correspond to a same serving cell (for example, reference serving cells are the same, where the reference serving cells may be determined according to Manner MN2)

The predefined Condition 3 may be that the DCI formats are DCI formats received in a same PDCCH monitoring occasion and corresponding to a same serving cell and without scheduling a PDSCH reception.

This method can clarify the ordering rule of DCI, clarify the ordering for DAI and/or the determination of a PUCCH resource, and can improve the reliability of uplink transmission.

### Manner MN14

DCI formats received in a same PDCCH monitoring occasion and corresponding to a same serving cell and without scheduling a PDSCH reception may be ordered according to DCI functionality. For example, a DCI format indicating SPS PDSCH release is before or after a DCI format indicating secondary cell dormancy.

This method can clarify the ordering rule of DCI, clarify the ordering for DAI and/or the determination of a PUCCH resource, and can improve the reliability of uplink transmission.

In some cases, the UE may be configured with one or more G-RNTIs and/or G-CS-RNTIs. The UE may also be configured with different HARQ-ACK feedback modes. The last DCI format may be determined by determining an order of multicast DCI formats by the following Manners MN15-MN19, and a PUCCH resource for carrying HARQ-ACK may be determined by the last DCI format.

### Manner MN15

A DCI format corresponding to HARQ-ACK feedback mode 1 (ACK/NACK) is after a DCI format corresponding to HARQ-ACK feedback mode 2 (NACK-only). That is, the DCI format corresponding to HARQ-ACK feedback mode 1 (ACK/NACK) is used to determine PUCCH resources first. This can increase the re-liability of HARQ-ACK transmission.

### Manner MN16

When multiple DCI formats satisfy the predefined Condition 2 (for example, when the multiple DCI formats are received in a same PDCCH monitoring occasion), they are arranged in an ascending (or descending) order of values of G-RNTIs or G-CS-RNTIs for scrambling the DCI formats.

This method can clarify the ordering rule of DCI and the determination of a PUCCH resource, and can improve the reliability of uplink transmission.

### Manner MN17

When multiple DCI formats satisfy the predefined Condition 2 (for example, when the multiple DCI formats are received in a same PDCCH monitoring occasion), a DCI format scrambled by a G-RNTI is before (or after) a DCI format scrambled by a G-CS-RNTI.

This method can clarify the ordering rule of DCI and the determination of a PUCCH resource, and can improve the reliability of uplink transmission.

### Manner MN18

It may be specified by protocols that the UE does not expect to receive more than one multicast DCI format indicating that HARQ-ACK is transmitted in a same PUCCH, in a same PDCCH monitoring occasion.

This method is simple to implement and can reduce the complexity of UE implementation.

### Manner MN19

When multiple DCI formats scrambled by G-CS-RNTIs and indicating SPS PDSCH release are received in a same PDCCH monitoring occasion, they are arranged in an ascending (or descending) order of values of the G-CS-RNTIs for scrambling the DCI formats.

This method can clarify the ordering rule of DCI and the determination of a PUCCH resource, and can improve the reliability of uplink transmission.

In some cases, the UE may be configured by higher layer signaling to support a DCI format scheduling multiple serving cells. When the UE receives a DCI format scheduling PDSCHs in multiple serving cells, how to generate a HARQ-ACK codebook is a problem that needs to be solved.

### Manner MN9

In some implementations, if the UE is configured with a semi-static HARQ-ACK codebook, it may be specified by protocols that the UE does not expect that a slot interval between any PDSCH of PDSCHs on the multiple serving cells scheduled by a DCI format and a PUCCH where HARQ-ACK for the PDSCH is transmitted is not in a configured set of K1.

This method can avoid expanding the set of K1 for generating the HARQ-ACK codebook when the semi-static HARQ-ACK codebook is configured, and can reduce the implementation complexity of the UE and the base station.

### Manner MN10

In some implementations, if the UE is configured with a semi-static HARQ-ACK codebook, it may be specified by protocols that for a DCI format scheduling PDSCHs in multiple serving cells, a TDRA table indicated in the DCI format may indicate PDSCH time domain resource allocation for each serving cell by reusing an existing TDRA table (for example, the parameter pdsch-TimeDomainAllocationList in the parameter PDSCH-Config) separately for each serving cell.

This method can avoid expanding the TDRA table when the semi-static HARQ-ACK codebook is configured, and can reduce the implementation complexity of the UE and the base station.

It should be noted that this method can also be applied to scenarios where other HARQ-ACK codebooks are configured, or it is not limited to the scenario where the semi-static HARQ-ACK codebook is configured.

It should be noted that the reused existing TDRA table may be a TDRA table corresponding to an active BWP.

### Manner MN11

In some implementations, the UE is configured with a dynamic HARQ-ACK codebook or an enhanced dynamic HARQ-ACK codebook. A HARQ-ACK sub-codebook may be generated separately for a DCI format scheduling one PDSCH and a DCI format scheduling multiple PDSCHs (e.g., PDSCHs in multiple serving cells). For the HARQ-ACK sub-codebook for the DCI format scheduling multiple PDSCHs, the number of HARQ-ACK bits corresponding to each DCI format may be determined in the following methods.
indicating by a parameter configured by higher layer signaling.
the maximum number of PDSCHs that can be scheduled by a DCI format. For example, the UE is configured with HARQ spatial multiplexing (harq-ACK-SpatialBundlingPUCCH). For another example, one PDSCH only contains one TB.
the maximum number of TBs that can be scheduled by a DCI format. For example, the UE is not configured with HARQ spatial multiplexing (harq-ACK-SpatialBundlingPUCCH).

This method can clarify the number of HARQ-ACK bits and improve the transmission reliability of the HARQ-ACK codebook.

### Manner MN20

In some implementations, the UE is configured with a dynamic HARQ-ACK codebook or an enhanced dynamic HARQ-ACK codebook. If the UE is not configured with HARQ spatial multiplexing (for example, the UE is not configured with a higher layer parameter harq-ACK-SpatialBundlingPUCCH), for a DCI format scheduling PDSCHs in multiple serving cells, the number N of the corresponding HARQ-ACK bits thereof may be the maximum number of TBs that can be scheduled. The maximum number of TBs that can be scheduled may be the sum of numbers of TBs that can be contained in one PDSCH on each serving cell (for example, all serving cells in a PUCCH group; for another example, all serving cells in a first set of serving cells).

It should be noted that the first set of serving cells in embodiments of the disclosure may be a set consisting of serving cells supporting joint scheduling of multiple serving cells (for example, a set of serving cells supporting joint scheduling of multiple serving cells contained in a PUCCH group).

When the UE receives a DCI format scheduling PDSCHs in multiple serving cells, HARQ-ACK bits for each PDSCH may be ordered according to at least one of the following rules.

Ordering rule 1: ordering in an ascending order (or a descending order) of indexes of serving cells scheduled by the DCI format. If the number M of HARQ-ACK bits corresponding to the PDSCHs on the serving cells scheduled by the DCI format (for example, M may be the maximum number of TBs that can be contained in the PDSCHs on the scheduled serving cells, and for example, M may be the sum of the maximum numbers of TBs that can be contained in one PDSCH, which correspond to all of the scheduled serving cells) is less than the N, the UE generates N-M bit NACK. The N-M bit NACK may be located after the M-bit HARQ-ACK information.

Ordering rule 2: ordering in an ascending order (or a descending order) of indexes of serving cells in the first set of serving cells. UE generates NACK for a serving cell without scheduling PDSCHs.

With respect to the above rules, if a serving cell is configured with reception of at most two TBs (for example, the higher layer parameter maxNrofCodeWordsScheduledByDCI is configured to 2), the UE generates 2-bit HARQ-ACK information for a PDSCH on this serving cell. If PDSCHs are not scheduled in the serving cell, the UE generates all NACK for the 2-bit HARQ-ACK. If the scheduled PDSCH on the serving cell only contains one TB, the UE generates 2-bit HARQ-ACK information, in which the first bit is the HARQ-ACK information for the TB (for example, determined according to the decoding result of the TB), and the second bit is NACK. If the scheduled PDSCH on the serving cell contains two TBs, the UE generates the 2-bit HARQ-ACK information according to the decoding results of the two TBs in the PDSCH.

If a serving cell is configured with reception of at most one TB (for example, the higher layer parameter maxNrofCodeWordsScheduledByDCI is configured to 1), the UE generates 1-bit HARQ-ACK information for one PDSCH on the serving cell. If PDSCHs are not scheduled in the serving cell, the UE generates NACK for the 1-bit HARQ-ACK. If a PDSCH is scheduled in the serving cell, the UE generates the 1-bit HARQ-ACK information according to the decoding result of the TB in the PDSCH.

This method clarifies the generation method of the HARQ-ACK codebook, and can improve the reliability of HARQ-ACK transmission and the spectrum efficiency.

### Manner MN21

In some implementations, the UE is configured with a dynamic HARQ-ACK codebook or an enhanced dynamic HARQ-ACK codebook. If at least one serving cell in a PUCCH group or the first set of serving cells is configured with reception of at most two TBs (for example, the higher layer parameter maxNrofCodeWordsScheduledByDCI is configured to 2), and the UE is not configured with HARQ spatial multiplexing (for example, the UE is not configured with the higher layer parameter harq-ACK-SpatialBundlingPUCCH), for a DCI format scheduling multiple PDSCHs, the number N of the corresponding HARQ-ACK bits may be the maximum number of PDSCHs that can be scheduled multiplied by 2. When the UE receives a DCI format scheduling PDSCHs in multiple serving cells, HARQ-ACK bits for the respective PDSCHs may be ordered according to at least one of the ordering rule 2 or the ordering rule 3.

Ordering rule 3: ordering in an ascending order (or a descending order) of indexes of the serving cell scheduled by the DCI format. If the number M of HARQ-ACK bits corresponding to the PDSCHs on the serving cells scheduled by the DCI format (for example, M may be the number of PDSCHs on the scheduled serving cells multiplied by 2) is less than the N, the UE generates N-M bit NACK. The N-M bit NACK may be located after the M-bit HARQ-ACK information.

For the ordering rule 2 or ordering rule 3, the UE generates 2-bit HARQ-ACK information for one PDSCH on the serving cell. If PDSCHs are not scheduled in the serving cell, the UE generates all NACK for the 2-bit HARQ-ACK. If the scheduled PDSCH on the serving cell only contains one TB, the UE generates the 2-bit HARQ-ACK information, in which the first bit is the HARQ-ACK information for the TB (for example, determined according to the decoding result of the TB), and the second bit is NACK. If the scheduled PDSCH on the serving cell contains two TBs, the UE generates the 2-bit HARQ-ACK information according to the decoding results of the two TBs in the PDSCH.

This method is simple to implement and can reduce the implementation complexity of the UE and the base station.

It should be noted that “TB” in the embodiments of the disclosure can also be replaced with “codeword (CW)”.

It should be noted that a scheduled serving cell in embodiments of the disclosure may be a serving cell indicated by a DCI format, or a serving cell where an valid PDSCH scheduled by a DCI format is located, where the valid PDSCH may be a PDSCH that does not overlap with uplink symbols configured by higher layer signaling (for example, uplink symbols configured by tdd-UL-DL-ConfigurationCommon or tdd-UL-DL-ConfigurationDedicated).

### Manner MN27

In some cases, the UE may be configured with multiple first sets of serving cells, and one or more of serving cells in each of the first sets may be scheduled by a same DCI format. In some implementations, the UE is configured with a dynamic HARQ-ACK codebook or an enhanced dynamic HARQ-ACK codebook. For a first set i of serving cells, a DCI format 1_3 schedules multiple PDSCHs in the first set of serving cells, and the number Ni of HARQ-ACK bits and the order for the PDSCHs may be determined according to the methods of other embodiments of the disclosure. And if Ni is less than Nmax, where Ni is a positive integer and Nmax is a positive integer, the UE generates Nmax-Ni NACK bits, which are located after the Ni HARQ-ACK bits.

The method clarifies the generation method of the HARQ-ACK codebook, and can improve the reliability of HARQ-ACK transmission and the spectrum efficiency.

It should be noted that, if the UE is configured with multiple first sets of serving cells, “the maximum number of PDSCHs that can be scheduled by a DCI format” in embodiments of the disclosure can be understood as the maximum number of PDSCHs that can be scheduled by the DCI format, separately corresponding to each of the first sets, or the maximum of the maximum number of PDSCHs that can be scheduled by the DCI format for each of the first sets, that is, in consideration of the numbers of serving cells in the respective first sets. “The maximum number of TBs that can be scheduled by a DCI format” can be understood as the maximum number of TBs that can be scheduled by a DCI format, corresponding to each of the first sets, or the maximum of the maximum numbers of TBs that can be scheduled by DCI formats for each of the respective first sets.

In some cases, a PUCCH may overlap with one or more PUSCHs in time domain. For example, the one or more PUSCHs may include a PUSCH scheduled by a DCI format that schedules one PUSCH (e.g., DCI format 0_0, DCI format 0_2) and a PUSCH scheduled by a DCI format that schedules more than one PUSCH (for example, DCI format 0_1). At least one of Manners MN22-MN24 may be adopted to determine a PUSCH to which UCI (e.g., HARQ-ACK and/or CSI) in the PUCCH is to be multiplexed. It should be noted that “scheduling more than one PUSCH” can be scheduling multiple PUSCHs in a same serving cell (for example, the UE is configured with multiple PUSCH time domain resource allocation list parameters, for example, the parameter pusch-TimeDomainAllocationListForMultiPUSCH) and/or scheduling multiple PUSCHs in different serving cells (for example, the UE is configured with PUSCH time domain resource allocation list parameters for multiple serving cells. For another example, the UE is configured with a parameter indicating enabling of a DCI format scheduling PUSCHs in more than one serving cell).

### Manner MN22

In some implementations, if a PUCCH overlaps with a PUSCH scheduled by a DCI format scheduling one PUSCH (for example, DCI format 0_0, DCI format 0_2) and a PUSCH scheduled by a DCI format scheduling more than one PUSCH (for example, DCI format 0_1) in time domain, the UE multiplexes UCI carried in the PUCCH in a PUSCH scheduled by the DCI format scheduling one PUSCH. Because some fields (such as DAI, or betaoffset) in the DCI format scheduling more than one PUSCH are the same for the multiple PUSCHs scheduled by the DCI format, the multiplexing of the UCI in the PUSCH scheduled by the DCI format scheduling one PUSCH can reduce the number of UCI bits and improve the reliability of uplink transmission. For example, DCI format 0_1 schedules two PUSCHs that overlap with two different PUCCHs carrying HARQ-ACK in time domain respectively. For a dynamic HARQ-ACK codebook, the numbers of HARQ-ACK bits corresponding to downlink DAI of 2 and 3 are 2 bits and 3 bits respectively. When multiplexing HARQ-ACK in a PUSCH, there may be only one uplink DAI field. If the uplink DAI indicates 3, when multiplexing a 2-bit HARQ-ACK codebook in the PUSCH, the number of bits of the HARQ-ACK codebook shall be expanded to 3 according to the uplink DAI field. The multiplexing of the HARQ-ACK in the PUSCH scheduled by the DCI format scheduling one PUSCH (for example, the uplink DAI indicates 2) can generate only 2-bit HARQ-ACK, thus reducing the number of UCI bits.

### Manner MN23

In some implementations, if a PUCCH overlaps with a PUSCH scheduled by a DCI format scheduling one PUSCH and a PUSCH scheduled by a DCI format scheduling more than one PUSCH in time domain, the UE multiplexes UCI carried in the PUCCH in a PUSCH scheduled by the DCI format scheduling more than one PUSCH. This can improve the reliability of data transmission in the PUSCH scheduled by the DCI format scheduling one PUSCH.

It should be noted that “a DCI format scheduling more than one PUSCH” can be understood as a DCI format that actually schedules more than one PUSCH (or a DCI format that nominally schedules more than one PUSCH; for example, the nominally scheduled PUSCH can be a PUSCH indicated in the DCI format), and/or a DCI format that can schedule more than one PUSCH.

### Manner MN24

In some implementations, if a PUCCH overlaps with PUSCHs scheduled by multiple different types of DCI formats (for example, DCI format 0_0, DCI format 0_1, and/or DCI format 0_2) in time domain, the UE can determine to multiplex UCI carried in the PUCCH in a PUSCH according to the types of the DCI formats. For example, UE may multiplex the UCI carried in the PUCCH preferentially in a PUSCH scheduled by the DCI format 0_2. For another example, the UE may multiplex the UCI in the PUCCH preferentially in a PUSCH scheduled by the DCI format 0_1. For yet another example, the UE may multiplex UCI in the PUCCH preferentially in a PUSCH scheduled by the DCI format 0_0. This method can improve the flexibility of scheduling.

In some cases, the UE may be scheduled with PDSCHs in multiple serving cells by a DCI format (for example, DCI format 13), and/or the UE may be scheduled with PUSCHs in multiple serving cells by a DCI format (for example, DCI format 0_3). It should be noted that DCI format 1_3 and DCI format 0_3 are only exemplary descriptions, and may be other DCI formats. The scheduling method can be enabled by higher layer parameter configuration (or the UE may be configured to monitor the DCI format). It may be configured by Manner MN25.

### Manner MN25

According to some aspects of Manner MN25, the UE may be configured with a parameter that indicates enabling of a DCI format scheduling PDSCHs and/or PUSCHs in multiple serving cells (e.g., a higher layer parameter dci-Format1-3And0-3-r18). For example, this parameter may be configured by higher layer signaling.

In some implementations, if the UE is configured with the parameter that indicates enabling of the DCI format scheduling PDSCHs and/or PUSCHs of multiple serving cells (e.g., a higher layer parameter dci-Format1-3And0-3-r18), the UE may be configured to detect DCI format 0_3 and/or DCI format 1_3.

In some implementations, at least one of the following parameters (e.g., one of the following parameters) may be configured in a DCI format parameter (e.g., a higher layer parameter dci-FormatsExt-r18):
formats0-3-And-1-3, for example, used to indicate to monitor PDCCH for DCI format 0_3 and DCI format 1_3.
formats0-2-And-1-2, for example, used to indicate to monitor PDCCH for DCI format 0_2 and DCI format 1_2.
formats0-1-And-1-1And-0-3-And-1-3, for example, used to indicate to monitor PDCCH for DCI format 0_1, DCI format 11, DCI format 0_3 and DCI format 1_3.
formats0-2-And-1-2And-0-3-And-1-3, for example, used to indicate to monitor PDCCH for DCI format 0_2, DCI format 12, DCI format 0_3 and DCI format 1_3.
formats0-1-And-1-1And-0-2-And-1-2, for example, used to indicate to monitor PDCCH for DCI format 0_1, DCI format 11, DCI format 0_2 and DCI format 1_2.
formats0-1-And-1-1And-0-2-And-1-2And0-3-And-1-3, for example, used to indicate to monitor PDCCH for DCI format 0_1, DCI format 11, DCI format 0_2 and DCI format 1_2.

In some implementations, if a search space set s is a UE-specific search space (USS) set, the DCI format parameter (e.g., the higher layer parameter dci-FormatsExt-r18) may indicate monitoring PDCCH carrying a DCI format, where the DCI format may be at least one of the following:
DCI format 0_2 and DCI format 1_2
DCI format 0_3 and DCI format 1_3
DCI format 01, DCI format 1_1, DCI format 0_2 and DCI format 1_2
DCI format 0_1, DCI format 1_1, DCI format 0_3 and DCI format 1_3
DCI format 02, DCI format 1_2, DCI format 0_3 and DCI format 1_3
DCI format 0_1, DCI format 1_1, DCI format 02, DCI format 12, DCI format 0_3 and DCI format 1_3

In some implementations, configurations (e.g., fields) in DCI format 0_3 and/or DCI format 13 may include one or more of the following:
an NDI field, configured separately for each TB, that is, each TB with a corresponding NDI field.
a RV field, configured separately for each TB, that is, each TB with a corresponding RV field.
a serving cell indicator (or carrier indicator) field (or serving cell set indicator field), used to indicate one or more serving cells scheduled by the DCI format. In embodiments of the disclosure, the serving cell indicator field is taken as an example for explanation.
a TDRA field, where a TDRA row may indicates a set of {K0 or K2, PUSCH allocation or PDSCH allocation} (which may be referred to as a set of TDRA information) for one or more serving cells, where the PUSCH allocation or PDSCH allocation may contain {mapping type, SLIV}, and the PUSCH allocation or PDSCH allocation may also contain at least one of mapping type, SLIV, starting symbol, length, and number of repetitions (transmission repetitions), number of slots or expanded K2. Or, a TDRA row may indicate a set of {K0 or K2, mapping type, SLIV, number of repetitions} for one or more serving cells. Or, a TDRA row may indicate a set of {K0 or K2, mapping type, SLIV, number of repetitions, number of repetitions} separately for one or more serving cells. The definition of parameter K0 or K2 may refer to the description of various embodiments of the disclosure.

In some implementations, if the number of repetitions (transmission repetitions) is not configured in a TDRA configuration (e.g., a TDRA table), when the UE receives a DCI format 1_3, it may be specified that the scheduled PDSCH is not transmitted with repetitions (or the number of repetitions is 1), or it may be specified that the number of repetitions is determined for the scheduled PDSCH (for example, determined separately for each serving cell) according to a parameter pdsch-AggregationFactor configured in the information element (IE) PDSCH-Config. 1f the number of repetitions is not configured in the TDRA configuration (e.g., the TDRA table), when the UE receives a DCI format 0_3, it may be specified that the scheduled PUSCH is not transmitted with repetitions (or the number of repetitions is 1), or it may be specified that the number of repetitions is determined for the scheduled PUSCH (e.g., determined separately for each serving cell) according to the parameter pusch-AggregationFactor configured in the IE PUSCH-Config.

In a method for receiving PDSCH according to some embodiments of the disclosure, the UE first receives a PDCCH carrying a first DCI format. For example, the first DCI format may be a DCI format scheduling PDSCH receptions in multiple serving cells (e.g., DCI format 1_3). The UE receives the PDSCHs in one or more serving cells according to information indicated by the first DCI format. The receiving of the PDSCHs may include receiving the PDSCHs in a determined time domain resource and/or frequency domain resource.

In the method for receiving PDSCH, the UE then determines a PUCCH resource according to the information indicated by the first DCI format, where the PUCCH resources is for carrying HARQ-ACK information for the PDSCH receptions.

In the method for receiving PDSCH, the UE finally transmits a PUCCH. For example, the PUCCH includes the HARQ-ACK information for the PDSCH receptions.

In a method for transmitting PUSCH according to some embodiments of the disclosure, the UE first receives a second DCI format. For example, the second DCI format may be a DCI format scheduling PUSCHs in multiple serving cells (e.g., DCI format 0_3). The UE may transmit the PUSCHs in one or more serving cells according to information indicated by the second DCI format.

In the method for transmitting PUSCH, the UE then determines time domain resource(s) and/or frequency domain resource(s) for the PUSCHs in the one or more serving cells according to the information indicated by the second DCI format.

In the method for transmitting PUSCH, the UE finally transmits the PUSCHs in the determined time domain resource(s) and/or frequency domain resource(s).

The method according to Manner MN25 can improve the scheduling flexibility. In addition, the blind detection of the UE and the implementation complexity of the UE can be reduced by only configuring the DCI format that the UE needs to monitor.

### Manner MN26

In some implementations, the UE receives a DCI format 0_3 (for example, a DCI format 0_3 containing a UL DAI field) scheduling PUSCHs in multiple serving cells (or scheduling multiple PUSCHs), and if no PUCCH with HARQ-ACK overlaps with the scheduled PUSCHs in time domain, the UE does not multiplex the HARQ-ACK information in the PUSCH. That is, in case that there is no PUSCH transmission in a slot, if the UE would not transmit a PUCCH with HARQ-ACK (for example, a PUCCH in a single slot), the UE does not multiplex the HARQ-ACK information in the PUSCH in the slot. This method can avoid multiplexing the HARQ-ACK information in multiple PUSCHs, and thus can improve the reliability of PUSCH transmission, and reduce PUSCH retransmission, thereby improving the spectrum efficiency of the system.

FIG. 9 illustrates a flowchart of a method 900 performed by a terminal according to some embodiments of the disclosure.

Referring to FIG. 9, in operation S910, the terminal receives a plurality of DCI formats.

Then, in operation S920, the terminal determines an order of each DCI format of the plurality of DCI formats.

Next, in operation S930, the terminal determines an uplink transmission resource for transmitting HARQ-ACK information based on the determined order.

In some implementations, for example, the plurality of DCI formats may include at least two DCI formats scheduling downlink physical shared channel (PDSCH) receptions in a same serving cell. The determining of the order of each DCI format of the plurality of DCI formats may include determining an order of each DCI format of the plurality of DCI formats based on the following: the plurality of DCI formats being indexed first in an ascending order of times of the scheduled PDSCHs in the same serving cell for a same physical downlink control channel (PDCCH) monitoring occasion, second in an ascending order of serving cell indexes for the same PDCCH monitoring occasion, and third in an ascending order of PDCCH monitoring occasion indexes.

In some implementations, for example, the plurality of DCI formats may include a DCI format scheduling PDSCH receptions in a plurality of serving cells. The determining of the order of each DCI format of the plurality of DCI formats may include determining an order of the DCI format scheduling PDSCH receptions in the plurality of serving cells among the plurality of DCI formats, which may include: determining a reference serving cell related to indexing of the DCI formats from among the plurality of serving cells for the DCI format; and determining the order of the DCI format based on the determined reference serving cell related to indexing of the DCI formats.

In some implementations, for example, the determining of the reference serving cell related to indexing of the DCI formats from among the plurality of serving cells for the DCI format may include determining at least one of the following as the reference serving cell related to indexing of the DCI formats:
a serving cell with a largest index of the plurality of serving cells;
a serving cell with a smallest index of the plurality of serving cells;
a serving cell with a largest index of serving cells where PDSCHs that do not overlap with uplink symbols configured by higher layer signaling in time domain are located, of the plurality of serving cells; or
a serving cell with a smallest index of the serving cells where the PDSCHs that do not overlap with the uplink symbols configured by the higher layer signaling in the time domain are located, of the plurality of serving cells.

In some implementations, for example, the plurality of DCI formats may include a DCI format indicating secondary cell dormancy. The determining of the order of each DCI format of the plurality of DCI formats may include determining an order of the DCI format indicating secondary cell dormancy of the plurality of DCI formats, which includes: determining a reference serving cell related to indexing of the DCI formats for the DCI format; and determining the order of the DCI format based on the determined reference serving cell related to indexing of the DCI formats.

In some implementations, for example, the determining of the reference serving cell related to indexing of the DCI formats for the DCI format may include determining at least one of the following as the reference serving cell related to indexing of the DCI formats:
a serving cell with a largest index of serving cells configured to enable dormancy;
a serving cell with a smallest index of the serving cells configured to enable dormancy;
a serving cell with a largest index of serving cells for which the DCI format indicates dormancy; or
a serving cell with a smallest index of the serving cells for which the DCI format indicates dormancy.

In some implementations, for example, the plurality of DCI formats include at least one DCI format of a DCI format indicating HARQ-ACK retransmission, a DCI format indicating secondary cell dormancy, or a DCI format indicating HARQ-ACK information feedback for all HARQ processes. The determining of the order of each DCI format of the plurality of DCI formats may include determining an order of the at least one DCI format, which may include: determining a reference serving cell related to indexing of the DCI formats for the at least one DCI format; and determining the order of the at least one DCI format based on the determined reference serving cell related to indexing of the DCI formats.

In some implementations, for example, the determining of the reference serving cell related to indexing of the DCI formats for the at least one DCI format includes determining at least one of the following as the reference serving cell related to indexing of the DCI formats:
a primary serving cell;
a cell with a largest index configured by higher layer signaling;
a cell with a smallest index configured by higher layer signaling;
a cell of which an index is a sum of a maximum index value of cells and a predetermined value; or
a cell of which an index is a difference of a minimum index value of the cells and a predetermined value.

In some implementations, for example, the determining of the order of each DCI format of the plurality of DCI formats includes determining a last DCI format, which includes: determining the DCI format indicating HARQ-ACK information feedback for all HARQ processes among the plurality of DCI formats as the last DCI format.

In some implementations, for example, operations S910 and/or S920 and/or S930 and/or other additional operations may be performed based on the above-described various embodiments of the disclosure (for example, one or more of Manners MN3-MN8).

FIG. 10 illustrates a flowchart of a method 1000 performed by a terminal according to some embodiments of the disclosure.

Referring to FIG. 10, in operation S1010, the terminal determines a reference serving cell in case that a predefined condition is satisfied.

Then, in operation S1020, the terminal performs uplink transmission based on the determined reference serving cell.

In some implementations, for example, the predefined condition may include at least one of:
the terminal receiving a downlink control information (DCI) format scheduling physical downlink shared channel (PDSCH) receptions of plurality of serving cells;
the terminal receiving a DCI format without scheduling a PDSCH reception;
the terminal receiving a DCI format triggering hybrid automatic repeat request-acknowledgement (HARQ-ACK) retransmission;
the terminal receiving a DCI format indicating secondary cell deactivation; or
the terminal receiving a DCI format triggering a Type-3 HARQ-ACK codebook.

In some implementations, for example, the determining of the reference serving cell may include determining at least one of the following as the reference serving cell:
a serving cell with a largest index of serving cells where PDSCH receptions scheduled by the DCI format are located;
a serving cell with a smallest index of the serving cells where the PDSCH receptions scheduled by the DCI format are located;
a first serving cell of a set of serving cells indicated by the DCI format;
a last serving cell of the set of the serving cells indicated by the DCI format;
a serving cell with a smallest index of serving cells where PDSCHs that do not overlap with uplink symbols configured by higher layer signaling in time domain are located, of the set of serving cells indicated by the DCI format;
a serving cell with a largest index of the serving cells where the PDSCHs that do not overlap with the uplink symbols configured by higher layer signaling in the time domain are located, of the set of serving cells indicated by the DCI format;
a serving cell determined based on a carrier indicator in the DCI format; or
a serving cell where a PDCCH carrying the DCI format is located.

In some implementations, for example, performing uplink transmission based on the determined reference serving cell may include determining at least one of the following based on the reference serving cell:
an order of DCI formats;
downlink allocation index (DAI) counting; or
a PUCCH time unit carrying HARQ-ACK information.

In some implementations, for example, operations S1010 and/or S1020 and/or other additional operations may be performed based on the above-described various embodiments of the disclosure (e.g., one or more of Manners MN1-MN2).

FIG. 11 illustrates a flowchart of a method 1100 performed by a terminal according to some embodiments of the disclosure.

Referring to FIG. 11, in operation S1110, the terminal receives a DCI format that schedules PDSCH receptions in a plurality of serving cells.

Then, in operation S1120, the terminal generates a HARQ-ACK codebook.

In some implementations, for example, the terminal does not expect that a slot interval between any PDSCH reception of PDSCH receptions on the plurality of serving cells scheduled by the DCI format and a PUCCH that transmits HARQ-ACK information thereof is not in a configured set of timing parameter K1 associated with HARQ-ACK feedback.

In some implementations, for example, in case that the terminal is configured with a semi-static HARQ-ACK codebook, a time domain resource allocation (TDRA) table indicated by the DCI format reuses an existing TDRA table separately for each of the plurality of serving cells to indicate PDSCH time domain resource allocation for each serving cell.

In some implementations, for example, in case that the terminal is configured with a dynamic HARQ-ACK codebook or an enhanced dynamic HARQ-ACK codebook, a HARQ-ACK sub-codebook are separately generated for the DCI format scheduling PDSCH receptions in the plurality of serving cells and a DCI formats scheduling a PDSCH reception, where the number of HARQ-ACK bits corresponding to the DCI format scheduling PDSCH receptions in the plurality of serving cells is determined based on: a parameter configured by higher layer signaling; the maximum number of PDSCHs that can be scheduled by the DCI format; or the maximum number of TBs that can be scheduled by the DCI format.

In some implementations, for example, operations S1110 and/or S1120 and/or other additional operations may be performed based on various embodiments of the disclosure described above (e.g., various manners, such as one or more of Manners MN9-MN11).

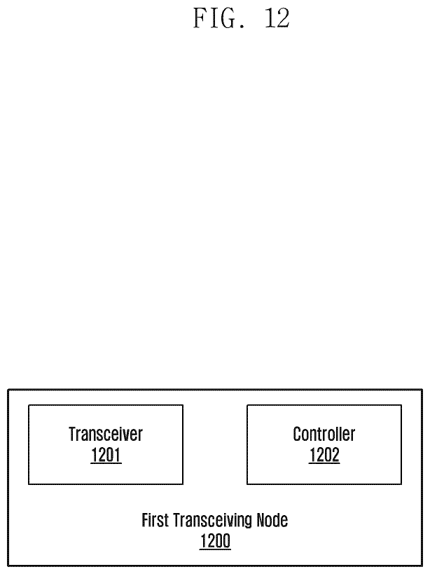

FIG. 12 illustrates a block diagram of a first transceiving node 1200 according to some embodiments of the disclosure.

Referring to FIG. 12, the first transceiving node 1200 may include a transceiver 1201 and a controller 1202.

The transceiver 1201 may be configured to transmit first data and/or first control signaling to a second transceiving node and receive second data and/or second control signaling from the second transceiving node in time units.

The controller 1202 may be an application specific integrated circuit or at least one processor. The controller 1202 may be configured to control the overall operation of the first transceiving node, including controlling the transceiver 1201 to transmit first data and/or first control signaling to a second transceiving node and receive second data and/or second control signaling from the second transceiving node in time units.

In some implementations, the controller 1202 may be configured to perform one or more operations in the methods of various embodiments described above.

In the following description, the first transceiving node is illustrated by taking a base station as an example (but not limited to), and the second transceiving node is illustrated by taking a UE as an example (but not limited to). The first data and/or first control signaling is illustrated by taking downlink data and/or downlink control signaling as an example (but not limited to). The HARQ-ACK codebook may be included in second control signaling, which is illustrated by taking uplink control signaling as an example (but not limited to).

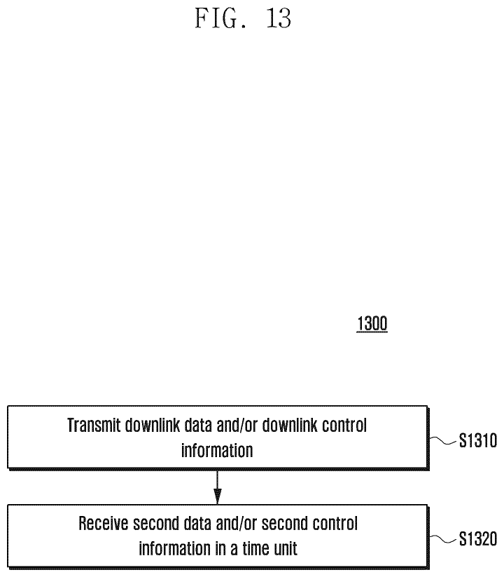

FIG. 13 illustrates a flowchart of a method 1300 performed by a base station according to some embodiments of the disclosure.

Referring to FIG. 13, in step S1310, a base station transmits downlink data and/or downlink control information.

In step S1320, the base station receives second data and/or second control information from a UE in time units.

For example, the method 1300 may include one or more of the operations performed by the base station described in various embodiments (e.g., various manners) of the disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1.-15. (canceled)

16. A method performed by a terminal in a wireless communication system, comprising:
receiving, from a base station, a plurality of downlink control information (DCI) formats for the terminal to provide hybrid automatic repeat request-acknowledgement (HARQ-ACK) information in a physical uplink control channel (PUCCH) in a same slot; and
transmitting, to the base station, the PUCCH which is indicated in a last DCI format among the plurality DCI formats,
wherein in case that a DCI format is associated with two or more scheduled cells, a scheduled cell with a smallest index among two or more scheduled cell is used for indexing the plurality of DCI formats.

17. The method of claim 16, wherein the plurality of DCI formats are indexed in ascending order across indexes of scheduled cells for a same physical downlink control channel (PDCCH) monitoring occasion, and indexed in ascending order across indexes of PDCCH monitoring occasions.

18. The method of claim 16, wherein a serving cell with a smallest index of the two or more scheduled cell is used as a reference serving cell for counting downlink assignment indicator (DAI).

19. The method of claim 16, wherein a number of HARQ-ACK information bit is determined based on a maximum number of physical downlink shared channels (PDSCHs) scheduled by a DCI format.

20. The method of claim 16, wherein a number of HARQ-ACK information bit is determined based on a maximum number of transport blocks scheduled by a DCI format.

21. The method of claim 16, wherein the plurality of DCI formats include a DCI format indicating secondary cell dormancy.

22. The method of claim 16, wherein the plurality of DCI formats include at least one of a DCI format indicating HARQ-ACK retransmission, a DCI format indicating secondary cell dormancy or a DCI format indicating HARQ-ACK information feedback for all HARQ processes.

23. A terminal in a wireless communication system, comprising:
a transceiver configured to transmit and receive signals; and
a controller coupled to the transceiver and configured to:
receive, from a base station, a plurality of downlink control information (DCI) formats for the terminal to provide hybrid automatic repeat request-acknowledgement (HARQ-ACK) information in a physical uplink control channel (PUCCH) in a same slot, and
transmit, to the base station, the PUCCH which is indicated in a last DCI format among the plurality DCI formats,
wherein in case that a DCI format is associated with two or more scheduled cells, a scheduled cell with a smallest index among two or more scheduled cell is used for indexing the plurality of DCI formats.

24. The terminal of claim 23, wherein the plurality of DCI formats are indexed in ascending order across indexes of scheduled cells for a same physical downlink control channel (PDCCH) monitoring occasion, and indexed in ascending order across indexes of PDCCH monitoring occasions.

25. The terminal of claim 23, wherein a serving cell with a smallest index of the two or more scheduled cell is used as a reference serving cell for counting downlink assignment indicator (DAI).

26. The terminal of claim 23, wherein a number of HARQ-ACK information bit is determined based on a maximum number of physical downlink shared channels (PDSCHs) scheduled by a DCI format.

27. The terminal of claim 23, wherein a number of HARQ-ACK information bit is determined based on a maximum number of transport blocks scheduled by a DCI format.

28. The terminal of claim 23, wherein the plurality of DCI formats include a DCI format indicating secondary cell dormancy.

29. The terminal of claim 23, wherein the plurality of DCI formats include at least one of a DCI format indicating HARQ-ACK retransmission, a DCI format indicating secondary cell dormancy or a DCI format indicating HARQ-ACK information feedback for all HARQ processes.
